(19) United States
(12) Patent Application Publication
(10) Pub. No.: US 2007/0137992 A1
(43) Pub. Date: Jun. 21, 2007

(54) Time-delay soft switch

(75) Inventor: George Marmaropoulos, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/598,197

(22) PCT Filed: Feb. 24, 2005
(86) PCT No.: PCT/IB05/50687

§ 371 Date: Aug. 21, 2006

Related U.S. Application Data
(60) Provisional application No. 60/549,191, filed on Mar. 2, 2004.

(51) Int. Cl. H01H 29/08

(52) U.S. Cl. 200/186

(57) ABSTRACT

There is provided a time-delay soft switch that has one or more first layers (10) of material with first elastomeric properties and one or more second layers of material with second elastomeric properties differing from those of the one or more first layers (10). One or more first layers (10) and/or one or more second layers (20) are each provided with at least one electrically conductive portion surface (12, 22). The time-delay switch provides, via the relative elastomeric properties of the layers, a time delay for opening and/or closing of an electric circuit that is compatible with the soft, flexible nature of a fabric.

The present invention relates to time-delay switches. More particularly, the present invention relates to a time-delay soft switch using the elastomeric properties of two or more materials relative to each other.

In smart fabric applications, it is frequently desirable to control the operation of electrical devices, such as those associated with some wearable electronics, by means of switches which operate on a predetermined time-delay. Conventionally, switches of this sort utilize mechanical, thermal and/or electrical means to obtain the desired time-delay interval. Other such devices use gravity operated mechanisms to realize a time-delay function. These conventional devices can be costly to manufacture, are normally structurally complex, comprise a substantial number of operative components including, for example, electrically-driven or spring-operated timing mechanisms, and have often proven to be operatively impractical, especially in textile or smart fabric applications.

Thus, it is useful to introduce a method and device that allows a time-delay for opening and/or closing an electric circuit, or the like, that is compatible with the soft, flexible characteristics of any of a variety of textiles or fabrics. It would be advantageous for such a device to be able to be compatible with various textile languages and/or systems without adding components, thereby enabling permanent integration.

It is an object of the present invention to provide a time-delay switch that operates using the elastomeric properties of two or more materials.

It is another object of the present invention to provide a time-delay switch for use any of a variety of pressure sensitive smart fabric applications.

It is another object of the present invention to provide a time-delay switch that is capable of seamless integration into a wearable fabric application.

It is another object of the present invention to provide a time-delay switch that has at least two conductive surfaces that are selectively connected and/or disconnected via the elastomeric characteristics of at least two different materials.

These and other objects and advantages of the present invention are achieved by a time-delay soft switch that has one or more first layers of material with first elastomeric properties. At least one of the one or more first layers has at least one first electrically conductive surface (12). The time-delay soft switch also has one or more second layers of material with second elastomeric properties. The one or more second layers can be connected to one or more third layers of material and at least one of the one or more third layers can have a second electrically conductive surface. The one or more first layers preferably covering closely the one or more second layers and the one or more third layers.

The present invention is more fully understood by reference to the following detailed description of an illustrative embodiment in combination with the drawings identified below.

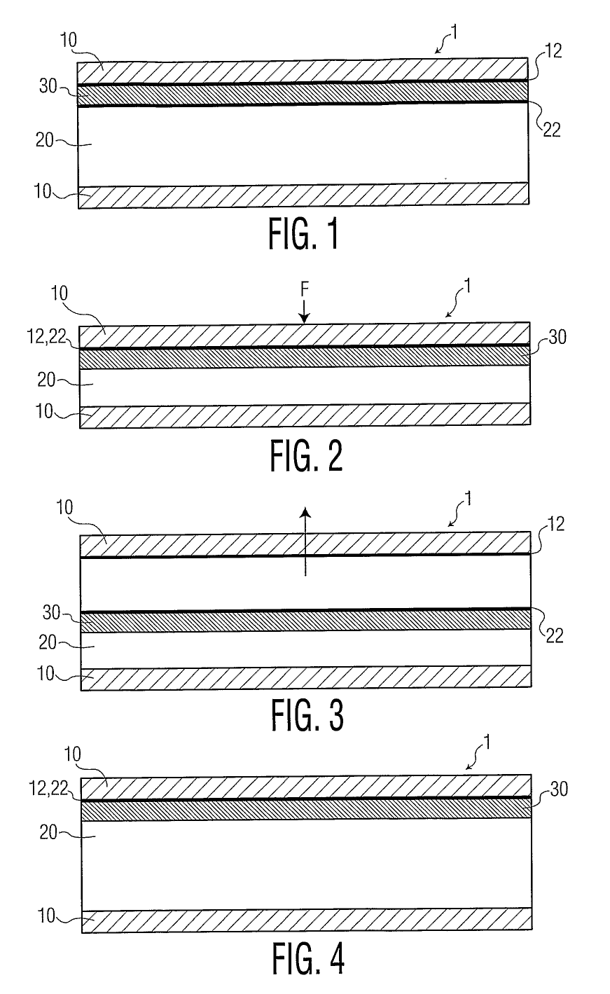

FIG. 1 is a schematic side section view of a time-delay soft switch in accordance with a first embodiment of the present invention, showing the switch in a first state;

FIG. 2 is another schematic side section view of the time-delay soft switch of FIG. 1, showing the switch in a second state;

FIG. 3 is still another schematic side section view of the time-delay soft switch of FIG. 1, showing the switch in a third state;

FIG. 4 is yet another schematic side section view of the time-delay soft switch of FIG. 1, showing the switch returned to the first state;

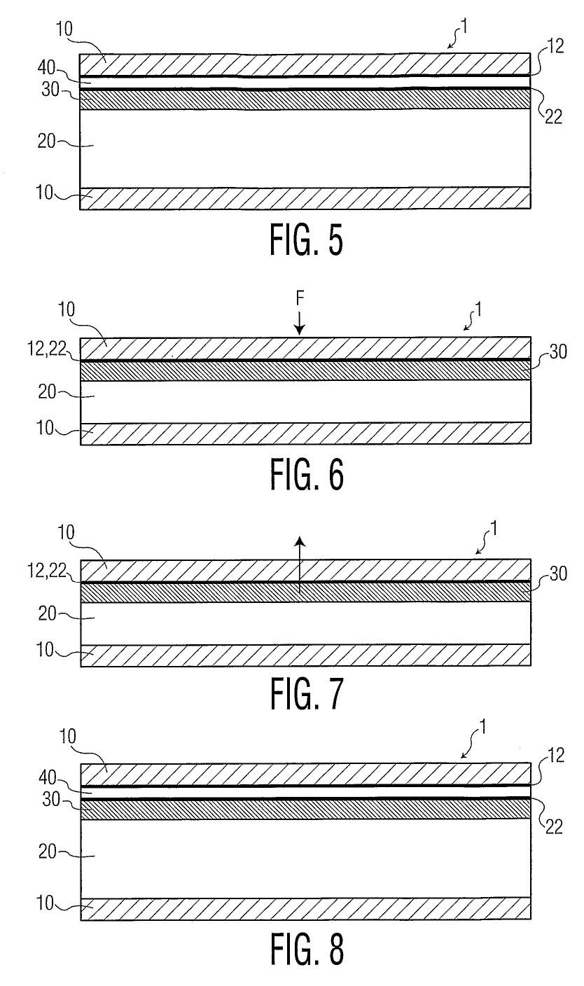

FIG. 5 is a schematic side section view of a time-delay soft switch in accordance with a second illustrative embodiment of the present invention, showing the switch in a first state;

FIG. 6 is another schematic side section view of the time-delay soft switch of FIG. 5, showing the switch in a second state;

FIG. 7 is still another schematic side section view of the time-delay soft switch of FIG. 5, showing the switch in a third state; and

FIG. 8 is yet another schematic side section view of the time-delay soft switch of FIG. 5, showing the switch returned to the first state.

Referring to the drawings and in particular, FIG. 1, there is shown a time-delay soft switch in accordance with an illustrative embodiment of the present invention generally represented by reference numeral 1. The time-delay soft switch I has one or more first layers 10 of material having first elastomeric properties and one or more second layers 20 of material having second elastomeric properties differing from those of one or more first layers 10. In addition, the time-delay soft switch 1 may have one or more third layers 30 of material having electrically conductive properties and suitable to be connected to one or more first layers 10 and/or one or more second layers 20.

As shown, in a preferred aspect of the present invention, one or more first layers 10 may preferably have at least one first electrically conductive portion and/or surface 12. First conductive surface 12 may be inherently conductive via the properties or configuration of one or more first layers 10. Alternatively, or in addition first conductive surface 12 may be made conductive using a conductive coating, for example, such as a conductive ink. First conductive surface 12 may be directly or indirectly connected to a power source and/or a separate electronic device (not shown).

Preferably, one or more first layers 10 of material may be made up of any of a variety of materials preferably having certain predefined elastomeric properties. For example, various polyurethane based materials may be used. The degree of elasticity associated with one or more first layers 10 can preferably be adjusted or modified as desired during fabrication or manufacture.

In a one aspect of the present invention, one or more first layers 10 preferably have a relatively high or fast elastic recovery with respect to one or more second layers 20. However, in another aspect of the present invention, one or more first layers 10 may have a relatively low elastic recovery or response relative to one or more second layers 20.

One or more first layers 10 can have any of a variety of constructions. For example, as shown, one or more first layers 10 can be a relatively shallow or flat foam, molded and/or formed using any of a variety of known conventional methods. Alternatively, one or more first layers 10 may be formed using fibers (not shown) having elastomeric properties. Also, one or more first layers 10 preferably have a sufficiently high tensile strength, weight and consistency to provide a high degree of durable flexibility during manufacture and/or use (e.g., flexible, resilient, corrosion resistant, etc.). Further, one or more first layers 10 may be natural and/or synthetic, and preferably can be shaped, sized and/or configured, using conventional methods, into a multitude of different patterns and/or forms to facilitate a variety of different applications in use, functional and/or aesthetic.

Regarding one or more second layers 20, as with first layers 10, preferably one or more second layers 20 can be formed from any of a variety of materials preferably having certain predefined elastomeric properties. The elastomeric properties of one or more second layers 20 preferably differ from those of one or more first layers 10. The degree of elasticity associated with one or more second layers 20 may, like first layers 10, be adjusted or modified as desired during fabrication or manufacture.

In a one aspect of the present invention, one or more second layers 20 preferably have a relatively low or slow elastic recovery with respect to one or more first layers 10. However, in another aspect of the present invention, one or more second layers 20 may have a relatively high elastic recovery or response relative to one or more first layers 10.

One or more second layers 20 can have any of a variety of constructions. For example, as shown, second layers 20 may be a lofted foam, molded and/or formed using various known conventional methods. Alternatively, as with first layers 10, one or more second layers 20 may be formed using fibers (not shown) with elastomeric properties or characteristics. Also, one or more second layers 20 can have a sufficiently high tensile strength, weight and consistency to provide a high degree of durable flexibility during manufacture and/or use (e.g., flexible, resilient, corrosion resistant, etc.). Further, one or more second layers 20 may be natural and/or synthetic, and can be shaped, sized and/or configured, using various conventional methods, into a multitude of different patterns and/or forms to facilitate a variety of different applications in use, functional and/or aesthetic.

In one aspect of the present invention, one or more second layers 20 can have at least one second electrically conductive portion and/or surface 22. Second conductive surface can be inherently conductive and/or made conductive using a conductive coating, for example, such as a conductive ink. The second conductive surface, like first conductive surface 12, can be directly or indirectly connected to a power source and/or a separate electronic device.

As shown, in a preferred aspect of the present invention, one or more third layers 30 of preferably electrically conductive material overlay one or more second layers 20 to provide the second conductive surface 22. One or more third layers 30 may have at least some elastomeric properties. Preferably, any elastomeric properties associated with one or more third layers 30 correspond proportionally to those of one or more second layers 20. The degree of conductivity and/or elasticity of one or more third layers 30 may, as with first layers 10 and second layers 20, be adjusted or modified as desired during fabrication or manufacture.

One or more third layers 30 can preferably have any of a variety of constructions. For example, third layers 30 can be a fiber mesh or web consisting of one or more electrically conductive fibers intertwined using known conventional methods for weaving, sewing and/or knitting, for example. The conductive fibers and/or one or more third layers 30 may have appropriate elastomeric properties and/or a high tensile strength, a weight and a consistency sufficient to provide a high degree of durable flexibility during manufacture and wear (e.g., flexible, resilient, corrosion resistant, etc.). One or more third layers 30 can have a variety of different shapes, sizes and/or configurations appropriate for various adaptations to accommodate different uses. One or more third layers 30 can have different conductivities and may be made of any suitable conductive material, including for example, a metalized foil, a conductive polymer, or a graphitized or metalized material.

Having identified and discussed some of the various aspects of the present invention, in use, time-delay soft switch 1 may be easily implemented to any of a variety of circuit applications. For example, the time-delay switch of the present invention may be seamlessly integrated as part of a pressure sensitive fabric application such as a wearable heart rate monitor, or as part of a pressure activated seat or seat cushion in such a manner so as to facilitate control and/or otherwise manipulate one or more electrical operations (e.g., power-on/power-off) associated with any of a variety of electronic devices. Other and/or alternative applications are also within the scope of the present invention.

As shown in FIG. 1, in accordance with a first embodiment of the present invention, one or more first layers 10 can be more elastically responsive relative to one or more second layers 20 and/or one or more third layers 30. In this embodiment, first layers 10 preferably cover one or more second layers 20 and/or one or more third layers 30 in a relatively tight or close manner when in a relaxed state. Also as shown, first conductive surface 12 and second conductive surface 22 are preferably electrically connected and may cooperate to open/close at least one circuit preferably associated with one or more electronic devices.

Referring to FIG. 2, as shown, first and second conductive surfaces 12, 22 preferably remain in contact and/or electrically connected when switch 1 is compressed via a force F, for example. The duration for which switch 1 remains in this compressed state after force F is removed and/or switch 1 is released preferably depends at least substantially on the elastic recovery rate of one or more first layers 10, which, as previously stated, may be adjusted during manufacture to satisfy any of a variety of timing requirements needed for a variety of applications in use.

Referring to FIG. 3, preferably one or more first layers 10 return to the relaxed state faster or sooner than one or more second layers 20 and/or one or more third layers 30 due at least substantially to the different elastic recovery rates, or the relative elastomeric properties, associated with the various layers. Consequently, first conductive surface 12 and second conductive surface 22 may preferably be disconnected for a predefined period of time or until one or more second layers 20 and/or one or more third layers 30 return to the relaxed state. The duration for which first and second conductive surfaces 12, 22 remain disconnected preferably depends on the elastic recovery rate of one or more first layers 10 with respect to those of one or more second layers 20 and/or one or more third layers 30.

Referring to FIG. 4, as shown, preferably once one or more second layers 20 and/or one or more third layers 30 return to the relaxed state, first and second conductive surfaces 12, 22 may be reconnected. It is noted that, as the elastomeric properties of the various layers 10, 20, 30 may be adjusted to be more or less elastically responsive relative to each other, the time period for which first and second conductive surfaces 12, 22 are connected and/or disconnected may likewise be adjusted as appropriate for an intended application in use.

Referring to FIG. 5, in accordance with a second embodiment of the present invention, one or more first layers 10 can be less elastically responsive to one or more second layers 20 and/or one or more third layers 30. In this embodiment, as shown, switch 1 preferably has essentially the same configuration as with the previous embodiment. However, in this embodiment, there is preferably a gap 40 separating one or more first layers 10 from one or more second layers 20 and/or one or more third layers 30 such that first conductive surface 12 and second conductive surface 22 are preferably electrically disconnected when in the relaxed state. It is noted that first and second conductive surfaces 12, 22 of this embodiment may likewise cooperate to open/close at least one circuit preferably associated with one or more electronic devices.

Referring to FIG. 6, as shown, first and second conductive surfaces 12, 22 preferably remain in separated and/or electrically disconnected until switch 1 is compressed via a force F, for example. The duration for which switch 1 remains in this compressed state after force F is removed and/or switch 1 is released preferably depends at least substantially on the elastic recovery rate of one or more first layers 10, which, as previously stated, may be adjusted during manufacture to satisfy any of a variety of timing requirements needed for a variety of applications in use.

Referring to FIG. 7, preferably one or more first layers 10 return to the relaxed state slower than one or more second layers 20 and/or one or more third layers 30 due at least substantially to the different elastic recovery rates, or the relative elastomeric properties, associated with the various layers. Consequently, first conductive surface 12 and second conductive surface 22 may preferably be connected for a predefined period of time or until one or more first layers 10 return to the relaxed state. The duration for which first and second conductive surfaces 12, 22 remain connected preferably depends on the elastic recovery rate of one or more first layers 10 with respect to those of one or more second layers 20 and/or one or more third layers 30.

Referring to FIG. 8, as shown, preferably once one or more first layers 10 return to the relaxed state, first and second conductive surfaces 12, 22 may be once again disconnected. It is noted that, as the elastomeric properties of the various layers 10, 20, 30 may be adjusted to be more or less elastically responsive relative to each other, the time period for which first and second conductive surfaces 12, 22 are connected and/or disconnected may likewise be adjusted as appropriate for an intended application in use.

The present invention having been thus described with particular reference to the preferred aspects thereof, it will be obvious that various changes and modifications may be made therein without departing from the spirit of the present invention a defined herein.

What is claimed is:

1. A time-delay soft (1) switch comprising:
one or more first layers (10) of material having first elastomeric properties, said one or more first layers (10) having at least one first electrically conductive surface (12); and
one or more second layers (20) of material having second elastomeric properties, said one or more second layers (20) having at least one second electrically conductive surface (22),
wherein said one or more first layers (10) closely cover said one or more second layers (20).

2. The time-delay soft switch (1) of claim 1, wherein said at least one second electrically conductive surface (22) is one or more third layers (30) of conductive material connected to said one or more second layers (20).

3. The time-delay soft switch (1) of claim 1, wherein said first elastomeric properties of said one or more first layers (10) are more responsive relative to said second elastomeric properties of said one or more second layers (20).

4. The time-delay soft switch (1) of claim 2, wherein the soft switch is seamlessly integrated into a pressure sensitive smart fabric application.

5. The time-delay soft switch (1) of claim 2, wherein said first and second electrically conductive surfaces (22) are electrically connected when the soft switch is in a relaxed state.

6. The time-delay soft switch (1) of claim 2, wherein said first and second electrically conductive surfaces (22) are electrically connected when the soft switch is in a compressed state.

7. The time-delay soft switch (1) of claim 3, wherein said first and second electrically conductive surfaces (22) electrically disconnect for a predefined period of time when the soft switch is compressed and released.

8. The time-delay soft switch (1) of claim 7, wherein said first and second electrically conductive surfaces (22) electrically reconnect after said predefined period of time.

9. The time-delay soft switch (1) of claim 7, wherein said predefined period of time is dependant on said first elastomeric properties of said one or more first layers (10) of material and said second elastomeric properties of said one or more second layers (20) of material.

10. The time-delay soft switch (1) of claim 3, wherein said one or more first layers (10) of material return to a relaxed state quicker than said one or more second layers (20) of material when the soft switch is compressed and released.

11. The time-delay soft switch (1) of claim 1, wherein said first elastomeric properties of said one or more first layers (10) of material are less responsive relative to said second elastomeric properties of said one or more second layers (20) of material.

12. The time-delay soft switch (1) of claim 11, wherein said at least one second electrically conductive surface (22) is one or more third layers (30) of conductive material connected to said one or more second layers (20).

13. The time-delay soft switch (1) of claim 11, wherein the soft switch is used in pressures sensitive smart fabric applications.

14. The time-delay soft switch (1) of claim 11, wherein said first and second electrically conductive surfaces (22) are electrically disconnected when the soft switch is in a relaxed state.

15. The time-delay soft switch (1) of claim 11, wherein said first and second electrically conductive surfaces (22) are electrically connected when the soft switch is in a compressed state.

16. The time-delay soft switch (1) of claim 12, wherein said first and second electrically conductive surfaces (22) electrically connect for a predefined period of time when the soft switch is compressed and released.

17. The time-delay soft switch (1) of claim 16, wherein said first and second electrically conductive surfaces (22) electrically re-disconnect after said predefined period of time.

18. The time-delay soft switch (1) of claim 16, wherein said predefined period of time is dependant on said first elastomeric properties of said one or more first layers (10) of material and said second elastomeric properties of said one or more second layers (20) of material.

19. The time-delay soft switch (1) of claim 12, wherein said one or more second layers (20) of material return to a relaxed state faster than said one or more first layers (10) of material when the soft switch is compressed and released.

20. The time-delay soft switch (1) of claim 1, wherein said one or more first layers (10) of material and said one or more second layers (20) of material operatively cooperate to selectively connect and/or disconnect said first and second electrically conductive surfaces (22), and thereby close a circuit, for a predefined period of time via a pressure interaction.
